(19) United States
(12) Patent Application Publication
(10) Pub. No.: US 2024/0156133 A1
(43) Pub. Date: May 16, 2024

(54) Composition and method of making a ready-to-drink protein shake that yields an ideal nutrition profile to aid in body recovery after exercise and provides a desired mouthfeel and perceived thickness in the absence of food thickeners

(71) Applicant: Jennifer Lynn Petitti, Downingtown, PA (US)

(72) Inventor: Jennifer Lynn Petitti, Downingtown, PA (US)

(21) Appl. No.: 17/988,388

(22) Filed: Nov. 16, 2022

(51) Int. Cl. A23L 2/66; A23C 9/12; A23C 9/13; A23L 2/56

(52) U.S. Cl. CPC A23L 2/66; A23C 9/1206; A23C 9/1307; A23L 2/56; A23V 2002/00

(57) ABSTRACT

The present invention relates to ready-to-drink protein shakes. In particular, the invention provides a desired mouthfeel and perceived thickness in the absence of food thickeners and contains an ideal nutrition profile to aid in whole body recovery of an exercising individual when consumed withing the anabolic window of the exercising individual.

### FIELD OF INVENTION

The present invention relates to beverages containing dairy with an improved texture/mouthfeel by the method of combining the ingredients in an all-in-one process. More specifically, the present disclosure relates to ready-to-drink (“RTD”) dairy containing beverages and product stability and the method for making the same. The method of making this RTD protein shake provides a desired texture/mouthfeel, perceived thickness, and a stable/smooth consistency in the absence of food thickeners. The ingredients of the RTD protein shake and the ratio of each ingredient provides adequate amounts of the nutrients: leucine, protein, carbohydrates, sodium and potassium. The nutrients of the RTD protein shake yield numerous health benefits to an exercising individual when consumed within the anabolic window following the exercise of that individual. The health benefits of this RTD protein shake are geared towards consumers looking for a product to stimulate the recovery of muscle protein synthesis, to improve glycogen resynthesis, and restore water balance and muscle function during the anabolic window following the exercise of that individual in the absence of food thickeners.

### BACKGROUND OF INVENTION

The increasing interest in eating cleaner, less processed foods in the diet by health-conscious consumers has led to a strong demand for food products that are more natural with fewer food additives. Today's consumer is looking for more natural food products without a compromise in taste or texture.

The method of blending milk, yogurt and flavoring creates a protein shake in the absence of food thickeners such as guar gum, carrageenan, xanthan gum, locust bean gum, oat and rice flour, corn fiber, pectin, corn starch, hickory root fiber, dextrin, and the like that are commonly found in most, if not all, protein shakes and meal replacement shakes currently available to consumers at this time. Examples of flavoring include but are not limited to chocolate syrup.

The present invention and method for making the same provides a ready-to-drink (RTD) protein shake which provides desirable sensory perception characteristics such as desired mouthfeel and perceived thickness without a high fat content as well as providing a stable and smooth consistency.

The use of traditional food thickeners is often used to achieve desired mouthfeel. However, there are a number of disadvantages with using traditional food thickeners as described above. First, the incorporation of food thickeners can result in a limited acceptance for consumers looking to eat more natural products. Second, protein shakes and meal replacement shakes containing traditional food thickeners may result in an aftertaste that may be undesirable to consumers.

In the absence of traditional food thickeners as mentioned above, and the method of combining the milk, yogurt and flavoring with the use of an immersion blender provide desirable sensory perception characteristics such as desired mouthfeel and perceived thickness without a high fat content.

In addition, a stable and smooth consistency is achieved.

The invention of this RTD protein shake is to aid in whole body recovery of an exercising individual when consumed withing the anabolic window of the exercising individual. This RTD protein shake contains the branch-chain amino acid, leucine, and protein in adequate amounts which stimulates the recovery of muscle protein synthesis when consumed within the anabolic window of the exercising individual.

This RTD protein shake also contains adequate amounts of carbohydrates to aid in glycogen resynthesis when consumed within the anabolic window of the exercising individual.

In addition, the ingredients and the ratios utilized to invent this RTD protein shake provides an adequate amount of the electrolytes, sodium and potassium, to restore water balance and muscle function after sweat loss due to exercise when consumed within the anabolic window of the exercising individual. This RTD protein shake is not low calorie.

There is a need in the food industry to provide a complete protein beverage without the addition of food thickeners. It would be desirable if such food compositions contained ingredients that consumers were familiar with and were free from food thickeners while providing adequate amounts of multiple desired nutrients that exercising individuals are looking for to aid in their recovery after exercising.

### SUMMARY OF THE INVENTION

The present disclosure provides a ready-to-drink (RTD) protein shake and also provides the method for making such a shake. The RTD protein shake can have a desired mouthfeel in the absence of food thickeners and provide an ideal nutrition profile to aid in the recovery of an exercising individual when consumed within the anabolic window following exercise of that individual.

The object of the current invention relates to solving the problem of no longer needing the use of food thickeners presently found in most, if not all, RTD dairy containing protein shakes and meal replacement shakes presently available to consumers.

The benefits of the current invention includes the following: Ability to produce RTD protein shake with desired mouthfeel, perceived thickness, and stable/smooth consistency in the absence of food thickeners, Ability to provide an ideal nutrition profile to stimulate the recovery of muscle protein synthesis, to improve glycogen resynthesis and restore water balance and muscle function after exercise in the absence of food thickeners when consumed during the anabolic window following the exercise of that individual.

Thus, the current invention solves the forgoing problem by providing a stable protein shake having improved mouthfeel and perceived thickness.

Provided is a composition of the protein shake, formed by combining milk, yogurt and flavoring (chocolate syrup).

The present invention provides a desired mouthfeel and perceived thickness similar to that of protein shakes with added food thickeners and method to make the same.

In a first aspect, the invention relates to a ready-to-drink (RTD) protein shake comprising: low fat 1% milk, non-fat, plain Greek yogurt and flavoring (chocolate syrup) wherein the ratio between the low fat 1% milk, non-fat, plain Greek yogurt and flavoring (chocolate syrup) are mixed in a weight ratio 0.5 to 1.0:1.0 to 1.5:0.01 to 0.1 and mixed with an immersion blender for 30 seconds to 1 minute.

The product of the invention presents desired mouthfeel and perceived thickness as well as a stable and smooth consistency even when no food thickeners are used.

Thus, using the novel approach by combining the low fat 1% milk; non-fat, plain Greek yogurt and flavoring (chocolate syrup) and the method of making the same, the invention not only improves product mouthfeel and perceived thickness but also provides an ideal nutrition profile to stimulate the recovery of muscle protein synthesis, to improve glycogen resynthesis and restore water balance and muscle function after exercise when consumed during the anabolic window following the exercise of that individual.

### DESCRIPTION OF PHOTOGRAPHS

FIG. 1A—Milk, yogurt and chocolate syrup mixed by hand for 30 seconds with a spoon resulting in a chunky, undesirable mouthfeel.

FIG. 1B—Milk, yogurt and chocolate syrup mixed by hand with a spoon resulting in a chunky, undesirable mouthfeel.

FIG. 2A—Milk, yogurt and chocolate syrup mixed by hand for 30 seconds with a fork resulting in a chunky, undesirable mouthfeel.

FIG. 2B—Milk, yogurt and chocolate syrup mixed by hand with a fork resulting in a chunky, undesirable mouthfeel.

FIG. 3A—Milk, yogurt and chocolate syrup mixed by hand for 30 seconds in a protein shaker with metal ball resulting in a frothy, undesirable mouthfeel.

FIG. 3B—Visible separation of milk and foam yielding an unstable consistency when using a protein shaker with metal ball.

FIG. 3C—Visible separation of the layers of foam and milk when using a protein shaker with metal ball.

FIG. 4A—Milk, yogurt and chocolate syrup mixed using a food processor for 30 seconds resulting in a frothy, undesirable mouthfeel.

FIG. 4B—Visible separation of milk and foam yielding an unstable consistency when using the food processor.

FIG. 4C—Visible separation of the layers of foam and milk when using the food processor.

FIG. 5A—Milk, yogurt and chocolate syrup mixed using a blender for 30 seconds resulting in a frothy, undesirable mouthfeel.

FIG. 5B Visible separation of milk and foam yielding an unstable consistency when using a blender.

FIG. 5C—Visible separation of the layers of foam and milk when using a blender.

FIG. 6A—Milk, yogurt and chocolate syrup mixed using an immersion blender for 30 seconds resulting in desired mouthfeel, perceived thickness and a smooth and stable consistency.

FIG. 6B—Minimum froth and foam resulted when using the immersion blender resulting in a smooth, stable and desired consistency.

### DETAILED DESCRIPTION OF INVENTION

In the following description, the % values are in grams unless otherwise specified.

The present invention pertains to a protein containing beverage, more particularly to ready-to-drink (RTD) protein shakes. The present invention addresses the following issue: Poor product aftertaste and texture/mouthfeel of RTD protein shakes and meal replacement shakes.

The current solution to achieve desired mouthfeel, perceived thickness and obtain a smooth and stable consistency is to add food thickeners to RTD protein shakes and meal replacement shakes.

Advantageously and unexpectedly, a unique combination and method of making the same by combining the low fat 1% milk with non-fat, plain Greek yogurt and flavoring were found to provide desired mouthfeel and perceived thickness of the RTD protein shake. In addition, the ideal nutrition profile was found after calculating the ingredients and the ratios used in the RTD protein shake. The ingredients and their ratios provide adequate amounts of the nutrients of leucine, protein, carbohydrates, sodium and potassium which stimulates the recovery of muscle protein synthesis, improves glycogen resynthesis and restores water balance and muscle function after exercise when consumed during the anabolic window of the exercising individual.

The branch-chain amino acid, leucine, which is found in dairy products such as milk and yogurt, is an important nutrient that plays a role in the recovery of muscle protein synthesis post workout by increasing muscle growth and recovery when consumed within the anabolic window of the exercising individual.

Complete protein, found in animal products such as dairy, is an important macronutrient that plays a crucial role in the recovery of muscle protein synthesis post workout by aiding in muscle repair and growth when consumed within the anabolic window of the exercising individual.

Carbohydrates, which are often lacking in most readily available RTD protein shakes on the market and are found in each of the ingredients of this RTD protein shake, play a vital role in improving glycogen resynthesis post workout by allowing an exercising individual's body the ability to restore the glycogen lost during training.

The electrolytes, sodium and potassium, which are naturally found in dairy products such as milk and yogurt, are often lost through the sweat of an exercising individual and need to be replaced within the anabolic window to restore water balance and muscle function.

The composition of the present invention is designed so that it is suitable for the nutritional requirements of an exercising individual when consumed within the anabolic window of that exercising individual. Consequently, the composition of the present invention is comprised of 2.0 to 5.0 grams of leucine, 20 to 40 grams of protein, 0.5 to 0.7 grams per kilogram carbohydrates and contains 200 to 400 mg of sodium and 300 to 800 mg of potassium per 16 ounce serving.

Furthermore, the result of this RTD protein shake has desired mouthfeel and perceived thickness in the absence of food thickeners. The novel composition and method of making the same includes low fat 1% milk; non-fat, plain Greek yogurt and flavoring wherein the ratio between the low fat 1% milk, non-fat yogurt and flavoring are mixed in a weight ratio 0.25 to 0.75:0.5 to 1.0:0.01 to 0.10.

### EXAMPLES

The present invention is illustrated further herein by the following non-limiting examples.

In this and in all the other examples of the invention, amounts of ingredients are given as wt/wt % based on the whole product formulation of wt % ratio 37:54:9.

Milk containing 1% milk fat was used in preparation of all samples described in the examples below.

Non-fat, plain Greek yogurt was used in preparation of all samples described in the examples below.

Flavoring of chocolate syrup. Chocolate syrup was made by combining 1.25 cups of water, 1.50 cups of sugar, 1.0 cup of cocoa powder, 0.25 teaspoons of salt and whisking for 6 minutes until a temperate of 140 degrees Fahrenheit was achieved. Syrup was removed from heat and 1 teaspoon of vanilla extract was added. This chocolate syrup was used in preparation of all samples described in the examples below.

### Example 1

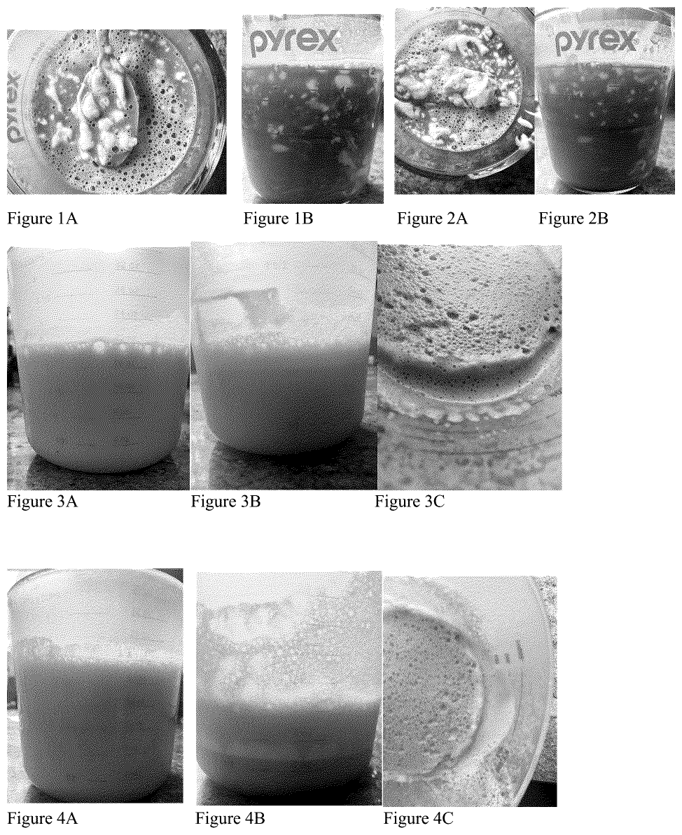

Milk, yogurt and chocolate syrup was added to a 2-cup (16 oz.) measuring cup and mixed by hand with a spoon for 30 seconds (FIG. 1A).

Results of the RTD protein shake are undesirable, as the yogurt did not blend with the milk and did not create desired mouthfeel, perceived thickness or obtain a smooth and stable consistency (FIG. 1B). The consistency is chunky, revealing clumps of yogurt.

### Example 2

Milk, yogurt and chocolate syrup was added to a 2-cup (16 oz.) measuring cup and mixed by hand with a fork for 30 seconds (FIG. 2A).

Results of the RTD protein shake are undesirable and similar to Example 1, as the yogurt did not blend with the milk and did not create desired mouthfeel, perceived thickness or obtain a smooth and stable consistency (FIG. 2B). The consistency is chunky, revealing clumps of yogurt.

### Example 3

Milk, yogurt and chocolate syrup was added to a 2 and ¼ cup (20 oz.) protein shaker with metal ball and shaken by hand for 30 seconds. The contents were then poured into a 4.5 cup (36 oz.) measuring cup (FIG. 3A).

Results of the RTD protein shake are less undesirable, as the yogurt did blend with the milk but did not create desired mouthfeel, perceived thickness or obtain a smooth and stable consistency. The consistency was frothy and the mixture was not stable as evidenced by the layer of foam on top (FIG. 3B, FIG. 3C).

### Example 4

Milk, yogurt and chocolate syrup was added to a food processor and mixed for 30 seconds and poured into a 4.5 cup (36 oz.) measuring cup.

Results of the RTD protein shake are undesirable. Although the yogurt did blend with the milk, the perceived mouthfeel was too thick and it did not result in a stable consistency. The consistency was frothy and the mixture was not stable as evidenced by the layer of foam on top (FIG. 4B, FIG. 4C).

### Example 5

Milk, yogurt and chocolate syrup was added to a blender and mixed for 30 seconds and poured into a 4.5 cup (36 oz.) measuring cup.

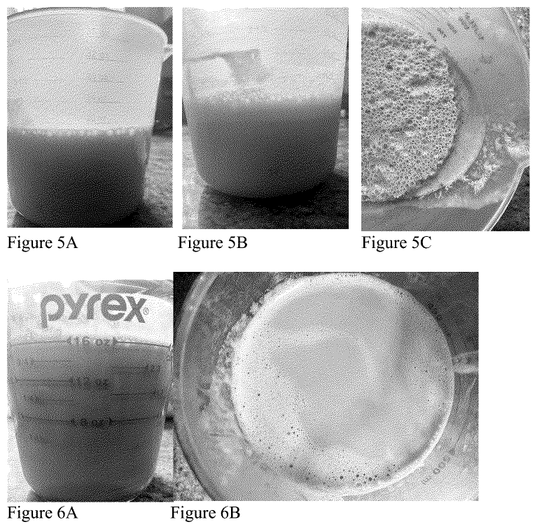

Results of the RTD protein shake are undesirable. Although the yogurt did blend with the milk, the perceived mouthfeel was still too thick and it did not result in a stable consistency. The consistency was frothy and the mixture was not stable as evidenced by the layer of foam on top (FIG. 5B, FIG. 5C) which is similar to Examples 3 and 4.

### Example 6

Milk, yogurt and chocolate syrup was added to 2-cup (16 oz.) measuring cup and mixed by an immersion blender for 30 seconds (FIG. 6A).

Results of the RTD protein shake are desirable. The invention result was desired mouthfeel, perceived thickness and a smooth and stable consistency with minimum foam (FIG. 6B).

The invention claimed is:

1. A ready to drink (RTD) protein shake comprising of: 1% fat dairy milk; plain, non-fat Greek yogurt; and flavoring such as chocolate syrup but not limited to.
a. Due to the natural ingredients of the RTD protein shake according to claim 1, the lactase enzyme can be added to allow those with lactose intolerance the ability to consume.

2. The method of making this RTD protein shake is with the use of an immersion blender which creates a drinkable yogurt.
a. The ingredients of this RTD protein shake are blended for 30 seconds to 1 minute in a weight ratio of 0.25 to 0.75:0.5 to 1.0:0.01 to 0.10 which provides a desired mouthfeel and perceived thickness in the absence of food thickeners while maintaining a stable consistency.

3. The composition of this RTD protein shake provides adequate amounts of the nutrients: leucine, protein, carbohydrates and the electrolytes (sodium and potassium) which aid in whole body recovery of an exercising individual when consumed within the anabolic window of the exercising individual.
a. A method of stimulating the recovery of muscle protein synthesis of an exercising individual according to claim 3, further comprising the step of consuming 2.0 to 5.0 grams of leucine during the anabolic window after exercise.
b. A method of stimulating the recovery of muscle protein synthesis of an exercising individual according to claim 3, further comprising the step of consuming 20 to 40 grams of protein during the anabolic window after exercise.
c. A method of improving glycogen resynthesis of an exercising individual according to claim 3, further comprising the step of consuming 0.5 to 0.7 grams per kilogram of carbohydrates during the anabolic window after exercise.
d. A method of adequately restoring water balance and muscle function of an exercising individual according to claim 3, further comprising the step of consuming 200 to 400 mg of sodium and 300 to 800 mg of potassium during the anabolic window after exercise.
